(19) United States
(12) Patent Application Publication
(10) Pub. No.: US 2025/0280795 A1
(43) Pub. Date: Sep. 11, 2025

(54) CAT WAND TOY

(71) Applicant: The Kyjen Company, LLC, Centennial, CO (US)

(72) Inventor: Danielle Salyer, Denver, CO (US)

(21) Appl. No.: 19/075,492

(22) Filed: Mar. 10, 2025

Related U.S. Application Data
(60) Provisional application No. 63/563,390, filed on Mar. 10, 2024.

(51) Int. Cl. A01K 15/02

(52) U.S. Cl. CPC A01K 15/025

(57) ABSTRACT

A pet toy includes a handle, at least one light source, a transparent or semitransparent shaft extending from the handle including a plurality of optical strands, a cord attached to the shaft, and a toy assembly coupled to the cord. The one or more optical strands are configured to radiate light generated by the at least one light source.

This application claims the benefit of priority to U.S. Provisional Application entitled “LED Cat Wand Toy,” filed Mar. 10, 2024, and assigned Ser. No. 63/563,390, the entire disclosure of which is hereby expressly incorporated by reference.

### BACKGROUND OF THE DISCLOSURE

### Field of the Disclosure

The disclosure relates generally to pet toys, and more specifically, to interactive pet toys including multiple functionalities configured to mentally stimulate pets.

### BRIEF DESCRIPTION OF RELATED TECHNOLOGY

Generally, a wide variety of pet toys are available to keep pets entertained. For example, pet toys including one or more of a squeaker, a bell, crinkle paper, and the like may be configured to make noise, entertaining pets. Other pet toys include balls, frisbees, wands, toys including treats (e.g., cat nip, pet treats), chew toys, and the like. However, pets may quickly become disinterested in their toys. Accordingly, there is a need for more dynamic and interactive pet toys including multiple functionalities that engage pets for longer or extended periods of time.

### SUMMARY OF THE DISCLOSURE

In accordance with one aspect of the present disclosure, a pet toy includes a handle, at least one light source, a transparent or semitransparent shaft extending from the handle including a plurality of optical strands, a cord attached to the shaft, and a toy assembly coupled to the cord. The one or more optical strands are configured to radiate light generated by the at least one light source.

In accordance with another aspect of the present disclosure, a pet toy includes a handle, at least one light source, a transparent shaft extending from the handle, the shaft including one or more optical strands, a cord attached to the shaft, a toy assembly coupled to the cord, the toy assembly including at least one additional light source. The one or more optical strands are configured to radiate light generated by the at least one light source.

In accordance with yet another aspect of the present disclosure, a pet toy includes a handle including at least one user input device, at least one light source, a transparent shaft extending from the handle, the shaft including one or more optical strands, a cord attached to a distal end of the shaft opposite the handle.

### BRIEF DESCRIPTION OF THE DRAWING FIGURES

For a more complete understanding of the disclosure, reference should be made to the following detailed description and accompanying drawing figures, in which like reference numerals identify like elements in the figures.

FIG. 1 illustrates a front view of a pet toy in accordance with one example of the present disclosure.

FIG. 2 illustrates a side view of a handle of the pet toy of FIG. 1 in accordance with one example of the present disclosure.

FIG. 3 illustrates a partial cross section view of a pet toy in accordance with one example of the present disclosure.

FIG. 4 illustrates an optical strand in accordance with one example of the present disclosure.

FIG. 5 illustrates a block diagram of a pet toy in accordance with one example of the present disclosure.

FIG. 6 illustrates a partial back view of a pet toy in accordance with one example of the present disclosure.

FIG. 7 illustrates a partial front view of pet toy in accordance with one example of the present disclosure.

While the disclosed pet toys and methods are susceptible of embodiments in various forms, there are illustrated in the drawings (and will hereafter be described) specific embodiments of the disclosure, with the understanding that the disclosure is intended to be illustrative and is not intended to limit the disclosure to the specific embodiments described and illustrated herein.

### DETAILED DESCRIPTION OF THE DISCLOSURE

The present disclosure is provided to solve the above-mentioned problems in the Background of the Disclosure section. Specifically, the present disclosure provides a pet toy having multiple functionalities providing a unique and dynamic playing experience for pets. In accordance with the present disclosure, a pet toy may include a handle, a clear (e.g., transparent, semi-transparent) shaft, one or more optical strands disposed in the shaft, at least one light source, a cord attached to the shaft, and a toy assembly removably coupled to the chord. According to the present disclosure, the one or more optical strands may be configured to radiate light generated by the at least one light source. The light radiated by the one or more optical strands may be visible through the shaft so as to engage or capture the attention of a pet.

In accordance with the present disclosure, when a person holds the handle, the toy assembly may hang or dangle, via the cord, from the shaft of the pet toy. Accordingly, a person holding the handle may dangle the toy assembly in front of a pet, enticing the pet to bat at or otherwise play with the toy assembly. In some examples, the toy assembly may include an attractant coupled to a body of the toy assembly configured to further attract or capture the attention of a pet. In addition to the toy assembly, the one or more optical strands may radiate light to attract or capture the attention of a pet. According to some examples, the one or more optical strands may be disposed in the shaft so as to form a recurring pattern or shape. According to some examples, the one or more optical strands may radiate light according to two or more different operational modes. In each of the operational modes, the one or more optical strands may radiate light having different colors (i.e., an assortment of colors), having different intensities, and/or in different sequences in which the one or more optical strands alternate between lit and unlit conditions, change colors, and/or change brightness.

According to some examples, the toy assembly may include an additional light source configured generate light for attracting or capturing the attention of a pet. In accordance with some examples, light may be alternating radiated by the one or more optical strands and the toy assembly so as to move a pet's attention between the one or more optical strands and the toy assembly. According to some examples, as described below in greater detail, a toy assembly according to the present disclosure may include one or more of catnip, bright colors, distinct or contrasting colors or images, distinct textures, and/or contrasting textures to attract or capture the attention of a pet.

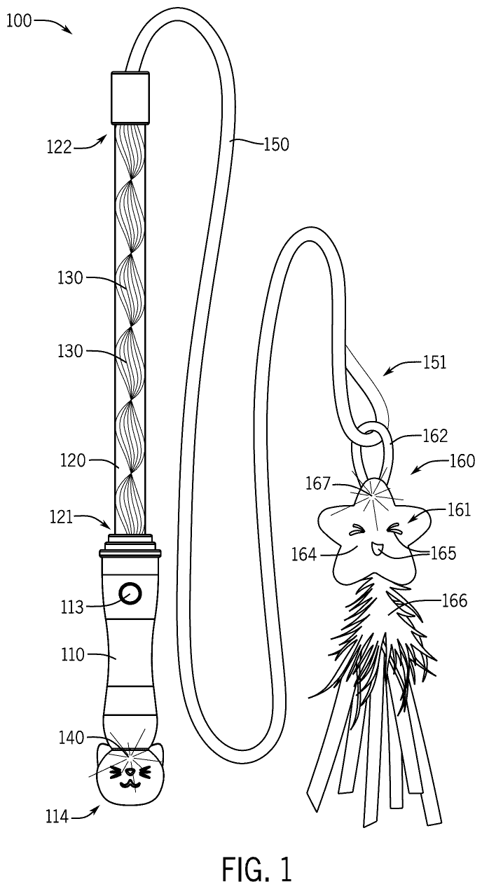

Referring to FIG. 1, a front view of a cat wand or pet toy 100 is illustrated in accordance with one example of the present disclosure. As shown in FIG. 1, the pet toy 100 may include a handle 110, a shaft 120 extending from the handle 110, one or more optical strands 130 disposed within the shaft 120, a light source 140, a cord 150 attached to the shaft 120, and a toy assembly 160 coupled to the cord 150. According to other examples, additional, fewer, or different components may be included.

The handle 110 may be configured to be held by a person or human playing with a pet. The handle 110 may have an ergonomic shape so as to be comfortably held within (e.g., a single) hand of a human. As noted above the toy assembly 160 may hang or dangle, via the cord 150, from the shaft 120 of the pet toy 100 when a person holds the handle 110 of the pet toy 100. In some examples, the handle 110 may be comprised of a plastic or plastics, such as, polypropylene (PP), polyethylene, polycarbonate, or other similar materials. In other examples, the handle 110 may be comprised of other materials.

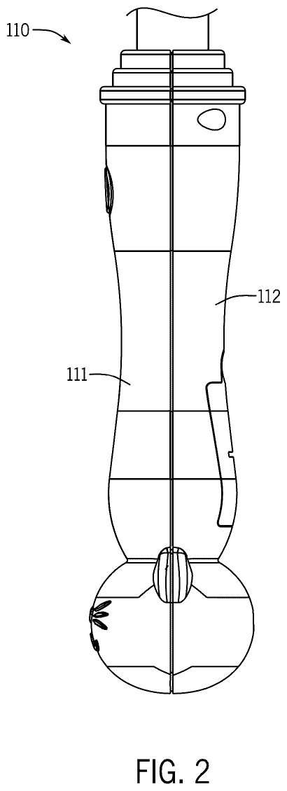

Referring to FIG. 2, a side view of a handle 110 of the pet toy 100 is illustrated in accordance with one example of the present disclosure. In some examples, as illustrated in FIG. 2, the handle 110 may include a front or first panel 111 and a back or second panel 112. In these examples, the first panel 111 and the second panel 112 may be coupled to one another, forming the handle 110. One or more fasteners, for example, screws, bolts, pins, rivets, nails, and the like may be used to couple the first panel 111 and the second panel 112.

Returning to FIG. 1, the pet toy 100 may further include a shaft 120 extending from the handle 110 (e.g., extending from one end of the handle 110). In some examples, the shaft 120 may be formed separately from and subsequently coupled to the handle 110. For example, the shaft 120 may be disposed between the first panel 111 and the second panel 112 of the handle 110. In some examples, the shaft 120 and the first panel 111 and/or second panel 112 may include mating features configured to maintain a position of the handle 110 and shaft 120 relative to one another. For example, the shaft 120 may include a rib or protrusion configured to be received in a groove or receptacle in the first panel 111 and/or second panel 112 of the handle 110 (e.g., disposed at an inner surface of the first panel 111 and/or second panel 112). In other examples, the shaft 120 and the handle 110 may be integrally formed as a single element of the pet toy 100.

According to some examples, as shown in FIG. 1, the shaft 120 may have a circular cross-sectional shape; however, the present disclosure is not limited thereto. In other examples, the shaft 120 may have a polygonal, elliptical, oval, or another cross-sectional shape. The shaft 120 may be clear (e.g., transparent, semi-transparent), such that light radiated by the one or more optical strands 130 is visible through the shaft 120. In some examples, the one or more optical strands 130 may be visible through the shaft 120. In some examples, the shaft 120 may be made of a plastic or plastics, such as acrylic, for example, polymethyl methacrylate (PMMA), or other similar materials. In accordance with other examples, the shaft 120 may be made of polypropylene (PP), polyethylene, polycarbonate, or other similar materials. In other examples, the shaft 120 may be made of another material. The shaft 120 includes a proximal end 121 disposed at or adjacent to the handle 110 and a distal end 122 opposite the proximal end 121. The distal end 122 is disposed further away from the handle 110 than the proximal end 121.

Referring generally to FIGS. 1 and 2, the handle 110 may further include one or more user input devices 113, for example, a button, switch, knob, lever, dial, touch or proximity sensor, or the like. The one or more user input devices 113 may be operatively coupled to the at least one light source 140. For example, the one or more user input devices 113 may be configured to turn the at least one light source 140 on and/off, change a functionality or operating mode of the at least one light source 140, and the like. An ergonomic shape of the handle 110 may further allow a person to operate one or more user input devices 113, for example, a button or switch, included in the handle 110, while comfortably holding the handle 110 (e.g., with the same hand). The one or more user input devices 113 may be configured to be operated or actuated by a thumb of a person holding the handle 110.

In accordance with some examples of the present disclosure, the handle 110 may further include a base 114 disposed at or near a bottom of the handle 110. In accordance with some examples, the base 114 of the handle 110 may be located closer to the body (e.g., torso) of a person holding the handle 110 than a shaft 120 of the pet toy 100. In accordance with some examples, as described hereinafter in greater detail, a light source 140 may be disposed in the base 114 of the handle 110. In some examples, the light source 140 disposed in the base 114 may be configured to illuminate the one or more optical strands 130. In some examples, the light source 140 disposed in the base may be another or additional light source, which may not illuminate the one or more optical strands 130, but instead may provide an additional source of illumination configured to attract or capture the attention of a pet. For example, the light source 140 disposed in the base 114 may be disposed within the handle 110 of the pet toy 100 and configured to illuminate or emit light through the handle 110, so as to attract or capture the attention of a pet.

The base 114 of the handle 110 may have various shapes. For example, the base 114 may be rounded. In accordance with some examples, the base 114 may be shaped to represent one or more aspects of an object or animal. For example, as shown in FIG. 1, the base 114 may be shaped to represent the head of a cat. In other examples, the base 114 may be shaped to represent a fruit or vegetable. The base 114 may be shaped to represent or have the shape of any item, object, or living thing.

The pet toy 100 may further include one or more optical strands 130 disposed within the shaft 120. The one or more optical strands 130 may be configured to radiate light generated by the one or more light sources 140. In some examples, as described hereinafter in greater detail, the at least one light source 140 may be disposed proximate to the one or more optical strands 130 and the one or more optical strands 130 may illuminate as light from the at least one light source 140 travels through and/or along the one or more optical strands 130. In accordance with other examples, the one or more light sources 140 may be disposed along the one or more optical strands 130.

Referring to FIG. 1, in accordance with some examples, the one or more optical strands 130 may extend along the length of the shaft 120. In accordance with some examples, as shown in FIG. 1, the one or more optical strands 130 may extend along the entire length of the shaft 120 in a predetermined pattern. For example, as shown in FIG. 1, the one or more optical strands 130 may be disposed in a repeating and continuous (e.g., linear) pattern, such as in a twisted fashion to create a wave-like pattern. A pattern of the one or more optical strands 130 may be configured to attract or capture the attention of pets, encouraging interaction with the pet toy 100.

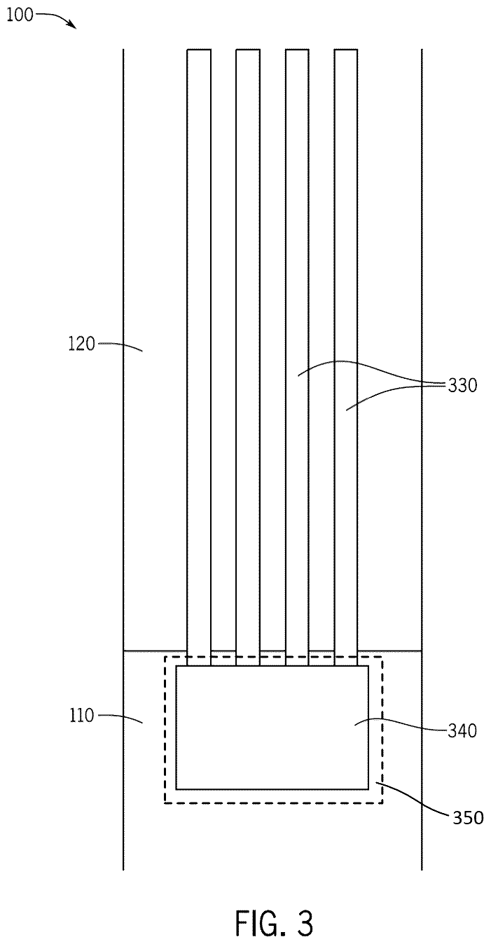

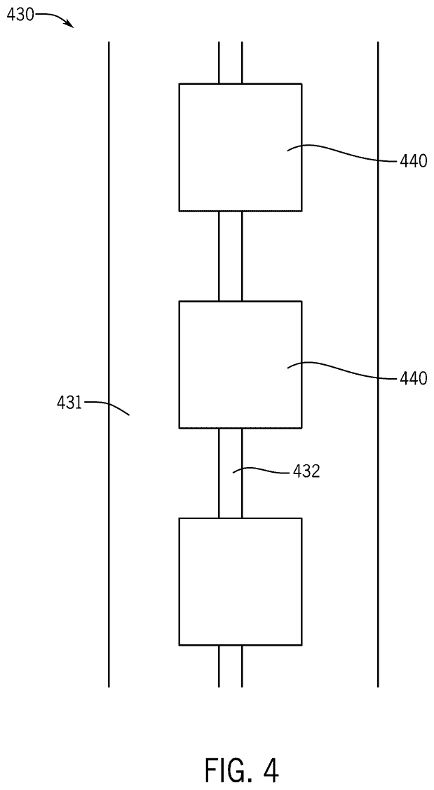

Referring to FIG. 3, a partial cross section view of the pet toy 100 is illustrated in accordance with one example of the present disclosure. In accordance with some examples of the present disclosure, the optical strands 130 and at least one light source 140 included in the pet toy 100 may be the optical strands 330 and the at least one light source 340 illustrated and described below with respect to FIG. 3. In accordance with other examples, the optical strands 130 and the at least one light source 140 included in the pet toy 100 may be the optical strands 430 and the at least one light source 440 illustrated and described below with respect to FIG. 4.

According to some examples, as illustrated in FIG. 3, the one or more optical strands 330 may receive light generated by the at least one light source 340 and illuminate as light from the at least one light source 340 travels along and out of the optical strands 330. Accordingly, in some examples, the one or more optical strands 330 may be made of a clear (e.g., transparent, semitransparent) material. The one or more optical strands 330 may be made of a clear (i.e., transparent or translucent) plastic or plastics. For example, the one or more optical strands 330 may be made of polycarbonate (PC), polyethylene terephthalate (PET), polyvinyl chloride (PVC), acrylic (e.g., polymethyl methacrylate), thermoplastic polyurethane (TPU), or the like. In other examples, the one or more optical strands may be made of other materials. According to some examples, the one or more optical strands 330 may be flexible.

In some examples, as shown in FIG. 3, the at least one light source 340 may be disposed in the handle 110 of the pet toy 100. For example, the light source 340 may be disposed between the first panel 111 and the second panel 112 of the handle 110. According to some examples, the at least one light source 340 may be at least one light emitting diode (LED). For example, the at least one LED may be multicolor or red, green, blue (RGB). For example, an RGB LED may be configured to emit light having a wavelength or color corresponding to the full spectrum of visible light. According to other examples, the at least one light source 340 may be at least one incandescent bulb, at least one fluorescent light, or another light source. According to some examples, the at least one light source 340 may comprise a plurality of LEDs. For example, the at least one light source may comprise two or more LEDs, each LED configured to emit light having a different wavelength or color.

In accordance with some examples of the present disclosure, the light source 340 may be disposed proximate to the one or more optical strands 330 and/or the shaft 120. For example, the light source 340 may be disposed between the one or more optical strands 330 and/or shaft 120 and a user input device 113 included in the handle 110. In accordance with some examples, the pet toy 100 may further include an (e.g., opaque) cover, screen, or blind 350 around a portion of any one, any combination, or all of (1) the light source 340; (2) the one or more optical strands 330; or (3) the shaft 120. The blind 350 may be configured to block light emitted by the light source 340, such that more of the light generated by the light source 340 is directed to the one or more optical strands 330 and/or the shaft 120. According to the present disclosure, the blind 350 may be provided as a housing surrounding a portion of the light source 340, the one or more optical strands 350, and/or the shaft 120. According to other examples, the blind 350 may be provided as a covering, for example, the blind 350 may be an (e.g., opaque) tape or coating (e.g., paint) applied to a portion of the light source 340, the one or more optical strands 330, and/or the shaft 120.

The one or more optical strands 330, or at least one end of each of the one or more optical strands 330, may be disposed proximate to the at least one light source 340. According to some examples, as shown in FIG. 3, the one or more optical strands 330 may extend into the handle 110 of the pet toy 100. For example, the one or more optical strands 330 may abut or contact the at least one light source 340 near the proximal end 121 of the shaft 120. In another example, the one or more optical strands 330 may extend further into the handle 110 and abut or contact or couple to the at least one light source 340 located at or near the base 114 of the handle 110. As noted above, the one or more optical strands 330 may be configured to radiate light generated by the at least one light source 340. Specifically, the one or more optical strands 330 may be disposed proximate to the at least one light source 340, such that when the at least one light source 340 generates or emits light, the light generated by the at least one light source 340 travels along or through the one or more optical strands 330. In these examples, as light generated by the at least one light source 340 travels through the one or more optical strands 330, the one or more optical strands 330 may illuminate, radiating the light generated by the at least one light source 340.

According to some examples, the one or more optical strands 330 may be multicolored. In some examples, each of the one or more optical strands 330 may be configured to absorb different wavelengths (e.g., colors) of light, such that light having a different wavelength (e.g., color) exits each of the plurality of optical strands 330. According to some examples, different portions of the same optical strand 330 may be configured to absorb different wavelengths (e.g., colors), such that different portions of the same optical strand 330 may radiate light having a different wavelength (e.g., color).

In accordance with some examples of the present disclosure, the one or more optical strands 330 may be configured to radiate light according to a plurality of (e.g., two or more) functional or operational modes. As noted above, a functional or operational mode of the at least one light source 340, and thus, the one or more optical strands 330, may be changed by actuating or operating the one or more user input devices 113. In addition to changing an operational mode of the at least one light source 340, the one or more user input devices 113 may be configured to turn the at least one light source 340 on and/or off.

The one or more optical strands 330 may be configured to radiate light according to a plurality of operational modes. The plurality of operational modes may attract or capture the attention of pets, encouraging pets to interact with the pet toy 100. In accordance with some examples, the at least one light source 340 may facilitate or dictate an operational mode of the pet toy 100.

The plurality of operational modes may include two or more modes in which the one or more optical strands 330 radiate light having a different wavelength or color. In some examples, the at least one light source 340 may include one or more light sources configured to emit light having various wavelengths or colors. In these examples, the one or more light sources 340 may be configured or controlled to emit light having a specific wavelength or color according to an operational mode of the pet toy 100. For example, the at least one light source 340 may include at least one RGB LED capable of emitting light having various wavelengths or colors. In accordance with other examples, the at least one light source 340 may include a plurality of light sources configured to emit light having different wavelengths of colors and one or more of the plurality of light sources may be configured or controlled to emit light having a specific wavelength or color according to an operational mode of the pet toy 100.

The plurality of operational modes may include one or modes in which the at least one light source 340 flashes or blinks on and off, such that the one or more optical strands 330 emit light in a flashing or blinking pattern. The at least one light source 340 may flash or blink in a regular or irregular pattern, such that light is radiated by the one or more optical strands 330 in a regular or irregular pattern. According to some examples, the plurality of operational modes may include two or more modes in which the light source 340 flashes or blinks, for example, at different speeds or intervals.

The plurality of operational modes may include one or more modes in which the one or more optical strands 330 radiate light which changes wavelengths or colors in a continuous cycle or pattern. For example, the at least one light source 340 may emit light which changes wavelengths or colors in a continuous cycle or pattern. Additionally, the one or more operational modes may include one or more modes in which the brightness of light radiated by the one or more optical strands 330 varies over time. For example, a brightness of light radiated by the one or more optical strands 330 may get brighter and dimmer in a continuous or repetitive pattern. Other operational modes that result in the light radiated by the one or more optical strands 330 changing may be used. A user may change operational modes by actuating the one or more user input devices 113, such as by pressing a button a certain number of times, holding the button down for a predetermined period, and the like.

Referring to FIG. 4, an optical strand 430 is illustrated in accordance with another example of the present disclosure. In accordance with some examples of the present disclosure, the one or more optical strands 130 included in the pet toy 100 may be optical strands 430 as illustrated and described below with respect to FIG. 4. Additionally, in some examples, the at least one light source 140 included in the pet toy 100 may be the plurality of light sources 440 illustrated and described below with respect to FIG. 4.

In some examples, as illustrated in FIG. 4, the at least one light source 140 may comprise a plurality of light sources 440 disposed along a length of the optical strand 430. For example, the one or more optical strands 430 may each include a base or substrate 431 and a plurality of light sources 440 may be coupled to the substrate 431. For example, the plurality of light sources 440 may be disposed at regular or irregular intervals along the substrate 431. According to some examples, the substrate 431 may be flexible. In some examples, the substrate 431 may be a printed circuit board (PCB). For example, the substrate 431 may be a flexible PCB including a core comprised of a flexible polymer.

According to some examples, the plurality of light sources 440 may be a plurality of LEDs. The plurality of light sources 440 may include multicolor LEDs, RGB LEDs, monochrome (e.g., single color) LEDs, or combinations thereof. According to other examples, the plurality of light sources 440 may be a plurality of incandescent bulbs, a plurality of fluorescent lights, or a plurality of other light sources. In accordance with some examples, the one or more optical strands 430 may include a trace or wire 432 connecting the plurality of light sources 440. In some examples, the trace or wire 432 may connect the plurality of light sources 440 to a power supply and/or controller.

In accordance with some examples of the present disclosure, the one or more optical strands 430 may be configured to radiate light according to a plurality of (e.g., two or more) functional or operational modes. According to the present disclosure, the one or more optical strands 430 and the plurality of light sources 440 may be configured to radiate light according to any of the operational modes described above with respect to the optical strands 330 and the at least one light source 340 of FIG. 3.

In addition to the operational modes described above with respect to FIG. 3, the plurality of operational modes may include one or more operational modes in which the plurality of light sources 440 disposed along at least one of the one or more optical strands 430 sequentially emit or radiate light. For example, the plurality of lights sources 440 may turn on and off in sequence creating a chase effect in which the plurality of light sources 440 illuminate one after another. Other operational modes configured to activate one or more of the plurality of light sources 440 in different configurations are possible.

Returning to FIG. 1, the pet toy 100 may further include a cord 150 coupled to the shaft 120. In some examples, as illustrated in FIG. 1, the cord 150 may be coupled to a distal end 122 of the shaft 120. In other examples, the cord 150 may be coupled to a center or midpoint of the shaft 120. The cord 150 may include a proximal end disposed at or coupled to the shaft 120 and a distal end opposite the proximal end. In some examples, the cord 150 may include a loop 151. Specifically, as illustrated in FIG. 1, a loop 151 may be disposed at a distal end of the cord 150. The cord 150 may be configured to be coupled to the toy assembly 160. In some examples, the loop 151 of the cord 150 may be configured to be coupled to an elastic loop 162 of the toy assembly 160. In some examples, the cord 150 may be made of nylon or another synthetic polymer. In other examples, the cord 150 may be made of another material.

Still referring to FIG. 1, the pet toy 100 may further include a toy assembly 160 (i.e., toy accessory). The toy assembly 160 may include a body 161 and a loop 162. As shown in FIG. 1, the toy assembly 160 may be coupled to the cord 150. For example, the loop 162 of the toy assembly 160 may be coupled to the cord 150, for example, the loop 151 of the cord 150. The loop 162 may be elastic and may be coupled to and/or extend from the body 161 of the toy assembly 160. The elastic loop 162 may be configured to couple the toy assembly 160 to the cord 150. In accordance with some examples of the present disclosure, the toy assembly 160 may be removably coupled to the cord 150. For example, the toy assembly 160 may be removably coupled to the cord 150, such that a person can swap out or change a toy assembly 160 coupled to the cord 150. In one or more examples, the loop 162 of the toy assembly 160 may be removably coupled to the cord 150. For example, the loop 162 of the toy assembly 160 may be interlocked with a loop 151 in the cord 150. In other examples, the loop 162 and the cord 150 may be tied to one another. In other examples, the toy assembly 160 may be (e.g., removably) coupled to the cord 150 in another way.

The body 161 of the toy assembly 160 may include a case or cover 164 and an internal compartment. The cover 164 may define an outer surface of the toy assembly 160. The cover 164 may be comprised of a plush textile. In some examples, the cover 164 may be comprised of a plush textile having pile (e.g., loops or strands) extending from the base textile. The cover 164 may be comprised of a polyester plush textile or fabric.

The internal compartment may be disposed within the cover 164 of the toy assembly 160. In some examples, the cover 164 may define a boundary of the internal compartment. The internal compartment of the toy assembly 160 may be stuffed with a filler material. The filler material may give the body 161 a voluminous, three-dimensional shape. In some examples, the filler material may be made of polyester or another synthetic material. In some examples, the filler material may include catnip in order to attract or capture the attention of a pet. For example, the catnip may encourage a pet to bat at, grab, bite, chew or otherwise play with the toy assembly 160 hanging (e.g., via the cord 150) from the shaft 120.

The body 161 of the toy assembly 160 may have various shapes. In some examples, as shown in FIG. 1, the body 161 may be shaped to represent a star. In other examples, the body 161 may be shaped to represent an animal, for example, a mouse. In still other examples, the body 161 may be configured to represent a fruit or vegetable. The body 161 may be shaped to represent or have the shape of any item, object, or living thing.

In some examples, the body 161 may further include one or more designs or images printed and/or embroidered on the cover 164 of the body 161, some of which are discussed below. The body 161 may include one or more decorative elements 165. The decorative element(s) 165 may be coupled to the cover 164 of the toy assembly 160. The decorative element 165 may be, for example, a design printed or embroidered on the cover 164. For example, a facial feature or features (e.g., eyes, nose, ears, mouth, eyebrows, or the like) may be printed or embroidered on the cover 164. In some examples, the toy assembly 160 may further include an attractant 166, for example, a tuft of faux fur or feather coupled to the cover 164 of the body 161.

One or more decorative elements 165 and/or attractants 166 may be sewn, glued, or otherwise coupled to the cover 164 of the toy assembly 160. The decorative element(s) 165 and/or attractant(s) 166 may be comprised of a different material, have a different color (or an assortment of colors), and/or have a different texture than the cover 164. Specifically, in some examples, the cover 164 and the decorative element 165 may have different textures, so as to attract a pet. In some examples, a textile or fabric of which the cover 164 is made and a textile or fabric of which the decorative element 165 is made may include pile or strands having different lengths. In other examples, the cover 164 and the decorative element 165 or attractant 166 may have contrasting colors, so as to attract a pet.

In accordance with some examples, the toy assembly 160 may further include an additional light source 167. For example, the toy assembly 160 may include an additional light source 167 disposed in an internal compartment of the toy assembly 160, visible from an exterior of the toy assembly 160 (e.g., through the cover 164) or may include an additional light source 167 coupled to an exterior surface of the cover 164. According to some examples, the toy assembly 160 may further include an additional user input device, for example, a button, or switch, disposed in the internal compartment of the toy assembly 160. The additional user input device may be configured to turn the additional light source 167 on and/or off and to change an operational mode of the additional light source 167. The additional light source 167 may be configured to emit or radiate light according to any of the operational modes described herein. For example, the additional light source 167 may be configured to emit or radiate light in accordance with any of the operational modes described above with respect to the optical strands 330 or 430 described above with respect to FIGS. 3 and 4. In some examples, the toy assembly 160 may further include a power supply and/or a controller connected to the additional light source and/or the additional user input device. The additional light source 167 may illuminate, attracting or capturing the attention of a pet. Further, the additional light source 167 may be configured to emit light according to two or more operational modes, providing a dynamic playing experience capturing a pet's attention for long or extended periods of time and/or over multiple playing sessions.

In some examples, the toy assembly 160 may further include a noisemaker. The noisemaker may be disposed within the body 161 of the toy assembly 160 (e.g., within the internal component) or coupled to the body 161 as an attractant 166. The noisemaker may be configured to make or produce a noise as the toy assembly 160 (and thus the noisemaker) moves. The noisemaker may include any of a bell, a rattle, crinkle paper, a whistle, a clicker, an electronic noise producing device, or the like, or any combination thereof.

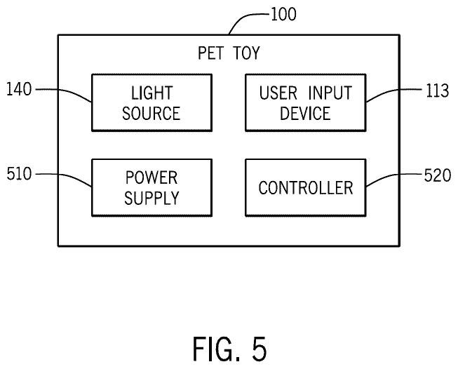

Referring to FIG. 5, a block diagram of the pet toy 100 is illustrated in accordance with one example of the present disclosure. As shown in FIG. 5, the pet toy 100 may include at least one light source 140, at least one user input device 113, a controller 520, and a power supply 510. The at least one light source 140 may be the at least one light source 340 as illustrated and described with respect to FIG. 3 or the at least one light source 440 as illustrated and described with respect to FIG. 4.

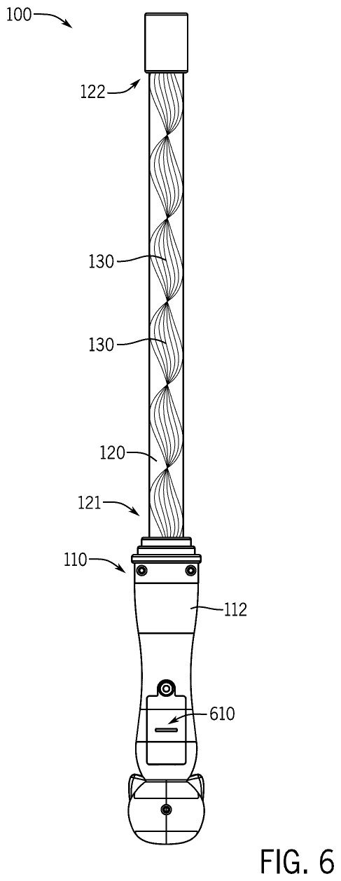

The power supply 510 may be connected to the at least one light source 140 and/or the controller 520. The power supply 510 may be configured to provide power (e.g., electric current) to the at least one light source 140. The power supply 510 may be a battery pack or compartment configured to receive one or more disposable or rechargeable batteries. In some examples, as shown in FIG. 6, the handle 110 of the pet toy may include a battery compartment 610 configured to receive one or more batteries.

In some examples, as shown in FIG. 5, the pet toy 100 may include a controller 520. The controller 520 may be connected to and/or in communication with the power supply 510, the at least one light source 140, and the at least one user input device 113. The controller 520 may be configured to provide one or more control signals and/or electric current to the at least one light source 140. The one or more control signals and/or electric current provided by the controller 520 may turn the at least one light source 140 on and/or off, change a color of light emitted by the at least one light source 140, change a brightness of the at least one light source 140, or control the at least one light source 140, such that light is radiated by the one or more optical strands 130 in accordance with one or more operational or functional modes, for example, one or more of the operational modes described above with respect to FIGS. 2 and 3.

The controller 520 may include a processor and memory. The memory may store one or more sets of rules or algorithms, for example, for controlling the at least one light source 140 such that light is radiated from the one or more optical strands 130 in accordance with a specific operational mode, and the processor may implement or execute the one or more sets of rules or algorithms. In accordance with some examples, the controller 520 may receive one or more user input signals from the at least one user input device 113 and control operation of the at least one light source 140 in accordance with the one or more user input signals.

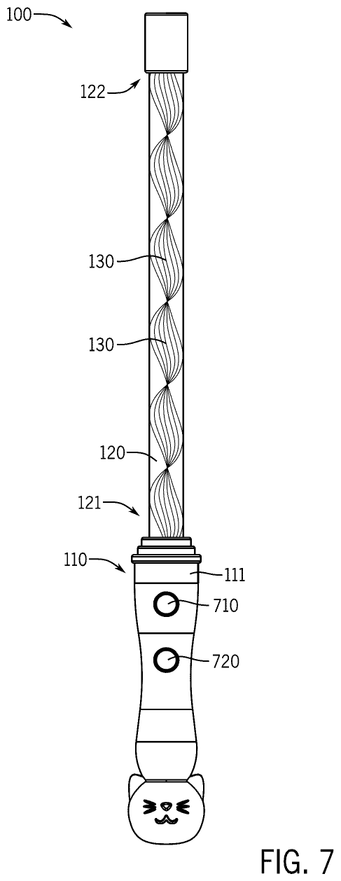

In accordance with some examples, as illustrated in FIG. 7, the pet toy 100 may include two user input devices. For example, the pet toy 100 may include a first user input device 710 and a second user input device 720. The first user input device 710 and the second user input device 720 may each be a user input device 113 as described above with respect to FIGS. 1 and 2. In accordance with some examples, the first user input device 710 and the second used input device 720 may be configured to perform different functions. For example, actuation of the first user input device 710 may turn the at least one light source 140 on and/or off, such that the one or more optical strands 130 are lit or illuminated (e.g., radiate light) or are unlit or unilluminated (e.g., do not radiate light), respectively. In accordance with some examples, when the first user input device 710 turns the at least one light source 140 on and/or off, actuation of the second user input device 720 may change any of a color of light emitted by the at least one light source 140, a brightness or intensity of light emitted by the at least one light source 140, and/or an operational or functional mode of the pet toy, for example, as described above with respect to FIGS. 3 and 4.

In accordance with other examples, the one or more optical strands 130 may radiate light having a first color, a first intensity, or according to a first operational mode when the first user input device 710 is depressed and radiate light having a second color, a second intensity, or according to a second operational mode when the second user input device 720 is depressed.

For clarity of disclosure, the terms “proximal” and “distal” are defined herein relative to a point of attachment of an element or relative to a person using the pet toy 100 of the present disclosure. The term “proximal” refers to the position of an element closer to the point of attachment or closer to a person holding the pet toy 100. The term “distal” refers to the position of an element further away from the point of attachment or further away from a person holding the pet toy 100.

While the present disclosure has been described with reference to specific examples, which are intended to be illustrative only and not to be limiting of the disclosure, it should be apparent to those of ordinary skill in the art that changes, additions and/or deletions may be made to the disclosed embodiments without departing from the spirit and scope of the disclosure.

The foregoing description is given for clarity of understanding only, and no unnecessary limitations should be understood therefrom, as modifications within the scope of the disclosure may be apparent to those having ordinary skill in the art.

When a component, device, element, or the like of the present disclosure is described as having a purpose or performing an operation, function, or the like, the component, device, or element, should be considered herein as being “configured to” meet that purpose or perform that operation or function.

What is claimed is:

1. A pet toy comprising:
a handle;
at least one light source;
a transparent or semitransparent shaft extending from the handle, the shaft including one or more optical strands configured to radiate light generated by the at least one light source;
a cord attached to the shaft; and
a toy assembly coupled to the cord.

2. The pet toy of claim 1, wherein the at least one light source is disposed in the handle.

3. The pet toy of claim 1, wherein the at least one light source comprises a plurality of light sources disposed along each of the one or more optical strands.

4. The pet toy of claim 1, wherein the toy assembly includes a body and a loop coupled to the body.

5. The pet toy of claim 4, wherein the body includes an additional light source.

6. The pet toy of claim 1, wherein the one or more optical strands comprise one or more light emitting diode strands and the at least one light source comprises a plurality of light emitting diodes disposed along each of the one or more light emitting diode strands.

7. The pet toy of claim 6, wherein the plurality of light emitting diodes disposed along each of the one or more light emitting diode strands includes a first light emitting diode configured to generate a first color of light and a second light emitting diode configured to generate a second color of light.

8. The pet toy of claim 1, wherein the one or more optical strands are arranged within the shaft so as to form a recurring pattern or shape.

9. The pet toy of claim 1, wherein a portion of each of the one or more optical strands are disposed in the handle.

10. The pet toy of claim 1, wherein the one or more optical strands abut the at least one light source.

11. The pet toy of claim 1, wherein the one or more optical strands are configured to radiate light generated by the at least one light source in accordance with two or more operational modes.

12. A pet toy comprising:
a handle;
at least one light source;
a transparent shaft extending from the handle, the shaft including one or more optical strands configured to radiate light generated by the at least one light source;
a cord attached to the shaft; and
a toy assembly coupled to the cord, the toy assembly including at least one additional light source.

13. The pet toy of claim 12, wherein the at least one light source is disposed in the handle.

14. The pet toy of claim 12, wherein the at least one light source is disposed in the shaft.

15. The pet toy of claim 12, wherein the at least one light source comprises a plurality of light sources disposed along each of the one or more optical strands.

16. The pet toy of claim 12, wherein the handle incudes two or more user input devices.

17. A pet toy comprising:
a handle including at least one user input device;
at least one light source;
a transparent shaft extending from the handle, the shaft including one or more optical strands configured to radiate light generated by the least one light source;
a cord attached to a distal end of the shaft opposite the handle; and
a toy assembly coupled to the cord.

18. The pet toy of claim 17, wherein the one or more optical strands are configured to radiate light generated by the at least one light source in accordance with two or more operational modes.

19. The pet toy of claim 18, wherein the user input device is configured to change an operational mode of the two or more operation modes of the pet toy.

20. The pet toy of claim 17, wherein the one or more optical strands are in contact with the at least one light source.
